(19) United States
(12) Patent Application Publication
(10) Pub. No.: US 2025/0057227 A1
(43) Pub. Date: Feb. 20, 2025

(54) ELECTRONIC VAPOUR PROVISION DEVICE

(71) Applicant: NICOVENTURES TRADING LIMITED, London (GB)

(72) Inventors: Damyn MUSGRAVE, London (GB); Jason WOOD, Winston Salem, NC (US); Jason SHORT, Winston Salem, NC (US); Stephen SEARS, Winston Salem, NC (US)

(21) Appl. No.: 18/720,001

(22) PCT Filed: Dec. 19, 2022
(86) PCT No.: PCT/EP2022/086784

§ 371 Date: Jun. 14, 2024

Related U.S. Application Data
(60) Provisional application No. 63/265,651, filed on Dec. 17, 2021.
(60) Provisional application No. 63/265,654, filed on Dec. 17, 2021.
(60) Provisional application No. 63/265,655, filed on Dec. 17, 2021.
(60) Provisional application No. 63/265,656, filed on Dec. 17, 2021.
(60) Provisional application No. 63/383,895, filed on Nov. 15, 2022.

(30) Foreign Application Priority Data
Jun. 20, 2022 (GB) 2209031.0
Jun. 20, 2022 (GB) 2209040.1
Jun. 20, 2022 (GB) 2209044.3
Jun. 20, 2022 (GB) 2209050.0

(51) Int. Cl. A24F 40/46; A24F 40/10; A24F 40/44; A24F 40/48; A24F 40/57; H05B 6/64

(52) U.S. Cl. CPC A24F 40/46; A24F 40/10; A24F 40/44; A24F 40/48; A24F 40/57; H05B 6/64

(57) ABSTRACT

An electronic vapor provision device is disclosed including an antenna arrangement for generating radio frequency (RF) electromagnetic radiation for heating a liquid to generate a vapor for inhalation by a user. The antenna arrangement includes a first section and a second section. The electronic vapor provision device also includes a controller for controlling the RF electromagnetic radiation generated by the antenna arrangement, an RF shield for shielding the user from RF electromagnetic radiation, wherein the RF shield at least in part defines a heating cavity within which the RF electromagnetic radiation generated by the antenna arrangement is contained, and an internal support structure arranged at least partially within the heating cavity and arranged between the first section and the second section of the antenna arrangement.

### RELATED APPLICATIONS

The present application is a National Phase entry of PCT Application No. PCT/EP2022/086784 filed Dec. 19, 2022, which claims priority to U.S. Provisional Application No. 63/265,651 filed Dec. 17, 2021, U.S. Provisional Application No. 63/265,654 filed Dec. 17, 2021, U.S. Provisional Application No. 63/265,655 filed Dec. 17, 2021, U.S. Provisional Application No. 63/265,656 filed Dec. 17, 2021, GB Application No. 2209044.3 filed Jun. 20, 2022, GB Application No. 2209040.1 filed Jun. 20, 2022, GB Application No. 2209050.0 filed Jun. 20, 2022, GB Application No. 2209031.0 filed Jun. 20, 2022 and U.S. Provisional Application No. 63/383,895 filed Nov. 15, 2022, each of which is hereby incorporated by reference in their entirety.

### TECHNICAL FIELD

The present disclosure relates to an electronic vapor provision device, an electronic vapor provision system and a method of generating a vapor.

### BACKGROUND

A known electronic vapor provision device comprises a vapor precursor material, such as liquid which is stored in a reservoir. The device also comprises a heater to heat the liquid in the reservoir so as to generate vapor from the liquid. A user is then able to inhale on the device, drawing air through a flow path which captures the generated vapor, allowing the material of the vapor to be inhaled by the user. In such a known device, the liquid in the reservoir may be heated using a resistive or inductive heater, to which electric energy is provided in order to heat a heating element. Once heated, the heating element in turn transmits heat to the vapor precursor material.

### SUMMARY

According to an aspect there is provided an electronic vapor provision device comprising:
an antenna arrangement for generating radio frequency (RF) electromagnetic radiation for heating a liquid to generate a vapor for inhalation by a user, wherein the antenna arrangement comprises a first section and a second section;
a controller for controlling the RF electromagnetic radiation generated by the antenna arrangement;
an RF shield for shielding the user from RF electromagnetic radiation, wherein the RF shield at least in part defines a heating cavity within which the RF electromagnetic radiation generated by the antenna arrangement is contained; and
an internal support structure arranged at least partially within the heating cavity, and arranged between the first section and the second section of the antenna arrangement.

Optionally, the internal support structure is non-shielding such that RF electromagnetic radiation is able to pass through the internal support structure.

Optionally, the internal support structure comprises one or more internal wicking members, optionally wherein the one or more internal wicking members are arranged to transfer a liquid from a liquid source by capillary action.

Optionally, the internal support structure comprises glass, fiberglass, ceramic, graphite, cotton or a polymer material.

Optionally, the internal support structure comprises a plurality of filaments or fibers.

Optionally, the internal support structure comprises a mesh.

Optionally, the internal support structure comprises a foam.

Optionally, the internal support structure comprises graphene foam or polyimide foam.

Optionally, the internal support structure is porous.

Optionally, the internal support structure is sintered.

Optionally, the antenna arrangement defines an internal volume within the antenna arrangement, and wherein the internal support structure extends within the internal volume.

Optionally, the internal support structure extends longitudinally within the internal volume.

Optionally, the internal volume extends longitudinally in the same direction as the internal support structure, and wherein the longitudinal ends of the antenna arrangement are open.

Optionally, the first section and second section correspond to portions of the same antenna.

Optionally, the first antenna section comprises a first antenna, and wherein the second antenna section comprises a second antenna.

Optionally, the internal support structure has a liquid capacity of 0.1 to 10 μl, optionally 0.1 to 5 μl.

Optionally, the internal support structure has a surface area to volume ratio of at least 0.4 mm⁻¹.

Optionally, the % open space of the internal support structure is 50 to 90%.

Optionally, at least a portion of the internal support structure extends through a portion of the RF shield.

Optionally, the RF shield comprises one or more liquid transport regions which are configured to receive fluid from one or more liquid sources and transport the received liquid through the RF shield and into the heating cavity.

Optionally, the internal support structure is configured to receive liquid from the one or more liquid transport regions.

Optionally, the internal support structure is in fluid communication with the one or more liquid transport regions.

Optionally, the electronic vapor provision device further comprises one or more liquid sources, each liquid source comprising a liquid reservoir.

Optionally, each liquid reservoir of a liquid source is arranged to deliver liquid to a corresponding transport region of the one or more transport regions, and wherein each liquid source further comprises a flow control element which is configured to control the flow of fluid from the liquid reservoir of said liquid source to the corresponding transport region.

Optionally, for each liquid source, the controller is configured to control the actuation of the flow control element of said liquid source so as to control the delivery of liquid from the liquid reservoir of the liquid source to the corresponding transport region of the one or more transport regions.

Optionally, each flow control element comprises a pump for pumping fluid through the one or more transport regions and into the internal support structure.

Optionally, the electronic vapor provision device further comprises one or more couplings, each coupling configured to receive a cartridge comprising a liquid reservoir.

Optionally, each coupling is arranged to deliver liquid from a liquid reservoir of a cartridge received by said coupling, to a corresponding transport region of the one or more transport regions.

Optionally, each coupling comprises a flow control element which is configured to control the flow of fluid from the liquid reservoir of said liquid source to the corresponding transport region, and wherein, for each coupling, the controller is configured to control the actuation of the flow control element of said coupling so as to control the delivery of liquid from a liquid reservoir of a cartridge coupled to said coupling, to the corresponding transport region of the one or more transport regions.

Optionally, each flow control element comprises a pump for pumping fluid through the one or more transport regions and into the internal support structure.

Optionally, the electronic vapor provision device comprises a plurality of internal wicking members, and a plurality of antenna arrangements for generating radio frequency (RF) electromagnetic radiation for vaporizing a liquid to form a vapor for inhalation by a user, each antenna arrangement being configured to direct RF electromagnetic radiation at a corresponding internal wicking member, and wherein the controller is configured to control the RF electromagnetic radiation generated by each antenna arrangement.

Optionally, each antenna arrangement of the plurality of antenna arrangements comprises a first section and a second section, and wherein each internal wicking member is arranged between the first section and the second section of the corresponding antenna arrangement.

Optionally, the controller is configured to independently control the RF electromagnetic radiation generated by each antenna arrangement.

Optionally, the RF shield comprises one or more air permeable regions which are configured to allow air and vapor to pass there through.

Optionally, the electronic vapor provision device further comprises an air outlet.

Optionally, the air outlet comprises a mouthpiece.

Optionally, the electronic vapor provision device further comprises an air inlet.

Optionally, the electronic vapor provision device further comprises an air flow path extending from the air inlet, into the heating cavity through the one or more air permeable regions, through the heating cavity, out of the heating cavity through the one or more air permeable regions, and to the air outlet.

Optionally, the one or more air permeable regions comprise a first air permeable region for air flow to enter the heating cavity and a second air permeable region for air flow to leave the heating cavity.

Optionally, the first and second air permeable regions are arranged at opposing ends of the heating cavity, optionally so as to direct airflow between the first section and second section, and along the internal support structure.

Optionally, the electronic vapor provision device further comprises a signal generator for generating a radio frequency signal to provide to the at least one antenna.

Optionally, the signal generator is configured to generate radiofrequency signals at one or more frequencies within the range of 30 Hz to 300 GHz.

Optionally, the electronic vapor provision device further comprises a radio frequency (RF) power amplifier for amplifying the radio frequency signal and transmitting an amplified radio frequency signal to the at least one antenna.

Optionally, the RF shield is configured to reflect more of RF electromagnetic radiation than is absorbed by the RF shield.

Optionally, the RF shield is configured to have a directional reflectance of 0.5 to 1.0 for the RF electromagnetic radiation generated by the at least one antenna.

Optionally, the RF shield is configured to have a directional absorptance of 0.0 to 0.7 for the RF electromagnetic radiation generated by the at least one antenna.

Optionally, the RF shield is configured to have a directional transmittance of 0.0 to 0.3 for the RF electromagnetic radiation generated by the at least one antenna.

Optionally, the RF shield is configured to have an effective attenuation coefficient of at least 0.05 mm⁻¹ for the RF electromagnetic radiation generated by the at least one antenna.

Optionally, the RF shield comprises aluminum.

Optionally, the RF shield comprises a reflective foil.

Optionally, the RF shield comprises a sheet metallic material.

Optionally, the RF shield comprises a metallic gauze or mesh.

Optionally, the RF shield comprises openings having a width of 5 mm or less.

Optionally, the RF shield comprises one or more regions containing openings, wherein the openings cover 20 to 80% of the area of said one or more regions.

Optionally, the RF shield comprises aluminum.

According to another aspect there is provided an electronic vapor provision device comprising:
at least one antenna for generating radio frequency (RF) electromagnetic radiation for heating an aerosol generating material to generate vapor;
a controller for controlling the RF electromagnetic radiation generated by the at least one antenna; and
an RF shield for shielding the user from RF electromagnetic radiation.

Any of the features described above may be applied to the electronic vapor provision device of this aspect.

According to another aspect there is provided an electronic vapor provision system comprising:
an electronic vapor provision device as described above; and
a supply of liquid which in use is vaporized to form a vapor for inhalation by a user.

According to another aspect there is provided a method of generating vapor comprising:
generating radio frequency (RF) electromagnetic radiation for heating a liquid to generate a vapor for inhalation by a user using an antenna arrangement comprising a first section and a second section;
controlling the RF electromagnetic radiation generated by the antenna arrangement;
providing an RF shield for shielding the user from RF electromagnetic radiation, wherein the RF shield at least in part defines a heating cavity within which the RF electromagnetic radiation generated by the at least one antenna is contained; and
providing an internal support structure arranged at least partially within the heating cavity, and arranged between the first section and the second section of the antenna arrangement.

### BRIEF DESCRIPTION OF DRAWINGS

Various embodiments will now be described, by way of example only, and with reference to accompanying drawings in which:

FIG. 1 shows a cross-sectional view through a schematic representation of an electronic vapor provision device according to various embodiments;

FIG. 2 shows a cross-sectional view through a schematic representation of a heating assembly of an electronic vapor provision device according to various embodiments;

FIG. 3 shows a cross-sectional view through a schematic representation of a heating assembly and liquid source according to various embodiments;

FIG. 4 shows a cross-sectional view through a schematic representation of a heating assembly and liquid source according to various embodiments;

FIG. 5 shows a cross-sectional view through a schematic representation of a heating assembly and liquid source according to various embodiments;

FIG. 6 shows a cross-sectional view through a schematic representation of a heating assembly and liquid source according to various embodiments; and

FIG. 7 shows a cross-sectional view through a schematic representation of a heating assembly and liquid source according to various embodiments.

### DETAILED DESCRIPTION

Aspects and features of certain examples and embodiments are discussed or described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to vapor provision devices, such as e-cigarettes, including hybrid devices. Throughout the following description the term “e-cigarette” or “electronic cigarette” may sometimes be used, but it will be appreciated this term may be used interchangeably with vapor provision system/device and electronic vapor provision system/device. Furthermore, and as is common in the technical field, the terms “vapor” and “aerosol”, and related terms such as “vaporize”, “volatilize” and “aerosolize”, may generally be used interchangeably.

An aerosol provision device is used to generate aerosol from an aerosol-generating material. Aerosol-generating material is a material that is capable of generating aerosol, for example when heated, irradiated or energized in any other way. Aerosol-generating material may, for example, be in the form of a solid, liquid or gel which may or may not contain an active substance and/or flavorants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid. The aerosol-generating material may comprise one or more active substances and/or flavors, one or more aerosol-former materials, and optionally one or more other functional material. In some embodiments, the aerosol-generating material comprises a crystalline structure.

The construction of the aerosol provision device may change depending upon the form of the aerosol-generating material which it is configured to generate aerosol from. However, while examples will be discussed below with regard to various different forms of aerosol-generating material, and correspondingly different aerosol provision device constructions, the heating techniques discussed herein may be applied in all forms of the aerosol-generating material.

Systems for generating aerosol often, though not always, comprise a modular assembly including both a reusable part (e.g. the aerosol provision device) and a replaceable (disposable) cartridge part, also referred to as a consumable. Often the replaceable cartridge part will comprise the vapor precursor material and the vaporizer and the reusable part will comprise the power supply (e.g. rechargeable battery), activation mechanism (e.g. button or puff sensor), and control circuitry. However, it will be appreciated these different parts may also comprise further elements depending on functionality. For example, for a hybrid device the cartridge part may also comprise the additional flavor element, e.g. a portion of tobacco, provided as an insert (“pod”). In such cases the flavor element insert may itself be removable from the disposable cartridge part so it can be replaced separately from the cartridge, for example to change flavor or because the usable lifetime of the flavor element insert is less than the usable lifetime of the vapor generating components of the cartridge. The reusable device part will often also comprise additional components, such as a user interface for receiving user input and displaying operating status characteristics.

For modular systems a cartridge and reusable device part are electrically and mechanically coupled together for use, for example using a screw thread, latching, friction-fit, or bayonet fixing with appropriately engaging electrical contacts. When the vapor precursor material in a cartridge is exhausted, or the user wishes to switch to a different cartridge having a different vapor precursor material, a cartridge may be removed from the device part and a replacement cartridge attached in its place. Devices conforming to this type of two-part modular configuration may generally be referred to as two-part devices or multi-part devices.

It is relatively common for electronic cigarettes to have a generally elongate shape and, for the sake of providing a concrete example, certain embodiments of the disclosure described herein will be taken to comprise a generally elongate single-part device employing a liquid reservoir containing liquid vapor precursor material. However, it will be appreciated the underlying principles described herein may equally be adopted for different electronic cigarette configurations, for example multi-part devices employing disposable cartridges containing vapor precursor material, or modular devices comprising more than two parts, refillable devices and single-use disposable devices, and hybrid devices which have an additional flavor element, such as a tobacco pod insert, situated along the air flow path and upstream of the vaporizer, as well as devices conforming to other overall shapes, for example based on so-called box-mod high performance devices that typically have a more box-like shape.

Various embodiments will now be described in more detail.

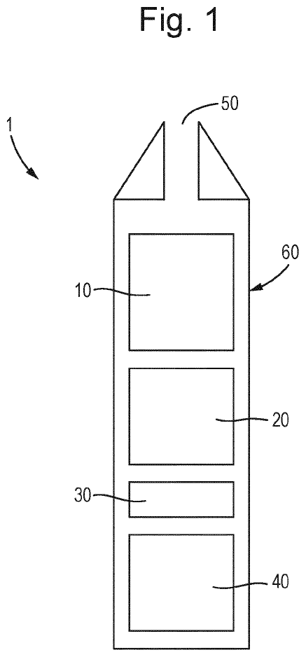

FIG. 1 is a cross-sectional view through a schematic representation of an electronic vapor provision device 1 in according to various embodiments.

The electronic vapor provision device 1 comprises an outer housing 60, a power source 40, control circuitry 30, a one or more liquid sources 20, and a heating apparatus 10. The outer housing 60 may be formed from any suitable material, for example a plastics material. The outer housing 60 may also enclose the other components, namely the power source 40, the control circuitry 30, the one or more liquid sources 20, and the heating apparatus 10. The electronic vapor provision device 1 is a handheld electronic vapor device, meaning that the outer housing 60 enclosing the other components is dimensioned and configured to be held in the hand of a user. In other words, the device is portable.

The electronic vapor provision device 1 may further include a mouthpiece 50. The outer housing 60 and mouthpiece 50 may be formed as a single component (that is, the mouthpiece 60 forms a part of the outer housing 60). The mouthpiece 50 may be defined as a region of the outer housing 60 which includes an air outlet and is shaped in such a way that a user may comfortably place their lips around the mouthpiece 50 to engage with air outlet. In FIG. 1, the thickness of the outer housing 60 decreases towards the air outlet 28 to provide a relatively thinner portion of the device 1 which may be more easily accommodated by the lips of a user. In other implementations, however, the mouthpiece 50 may be a removable component that is separate from but able to be coupled to the outer housing 60, and may be removed for cleaning and/or replacement with another mouthpiece 50.

The power source 40 is configured to provide operating power to the electronic vapor provision device 1. The power source 40 may be any suitable power source, such as a battery. For example, the power source 40 may comprise a rechargeable battery, such as a Lithium Ion battery. The power source 40 may be removable or form an integrated part of the electronic vapor provision device 1. In some implementations, the power source 40 may be recharged through connection of the device 1 to an external power supply (such as mains power) through an associated connection port, such as a USB port (not shown) or via a suitable wireless receiver (not shown).

The control circuitry 30 is suitably configured or programmed to control the operation of the aerosol provision device to provide certain operating functions of electronic vapor provision device 1. The control circuitry may also interchangeably be referred to as a “controller”. The control circuitry 30 may be considered to logically comprise various sub-units/circuitry elements associated with different aspects of the aerosol provision devices' operation. For example, the control circuitry 30 may comprise a logical sub-unit for controlling the recharging of the power source 40. Additionally, the control circuitry 30 may comprise a logical sub-unit for communication, e.g. to facilitate data transfer from or to the device 1. However, a primary function of the control circuitry 30 is to control the heating of aerosol generating material, as described in more detail below. It will be appreciated the functionality of the control circuitry 30 can be provided in various different ways, for example using one or more suitably programmed programmable computer(s) and/or one or more suitably configured application-specific integrated circuit(s)/circuitry/chip(s)/chipset(s) configured to provide the desired functionality. The control circuitry 30 is connected to the power supply 40 and may receive power from the power source 40 and may be configured to distribute or control the power supply to other components of the electronic vapor provision device 1. The control circuitry 30 is discussed as being connected to various components of the electronic vapor provision device 1, and it should be understood in each instance that this may be a direct or indirect connection.

The electronic vapor provision device 1 also comprises one or more liquid sources 20, each comprising a liquid reservoir containing liquid vapor precursor material. The liquid vapor precursor material may be referred to as an e-liquid. In embodiments, the one or more liquid sources 20 is arranged within the outer housing 60, but, as discussed above, in embodiments in which the electronic vapor provision device 1 is a multi-part or modular system, the one or more liquid sources 20 may be arranged within one or more disposable cartridges which are configured to be releasably coupled to the remainder of the electronic vapor provision device 1. That is to say, the cartridges are capable of being received by or in the vapor provision device 1.

Although specific embodiments are discussed in more detail below, each liquid reservoir may be formed in any shape compatible with the heating techniques discussed herein. The one or more liquid reservoirs may also be formed in accordance with conventional techniques, and for example it may comprise a plastics material, and may be integrally molded with the outer housing 60. It is noted that while the features discussed in this specific description are in the context of an aerosol generating material which is a liquid vapor precursor material, it is envisaged that these features may be applied to aerosol generating material of other forms, such as a solid or gel as discussed above.

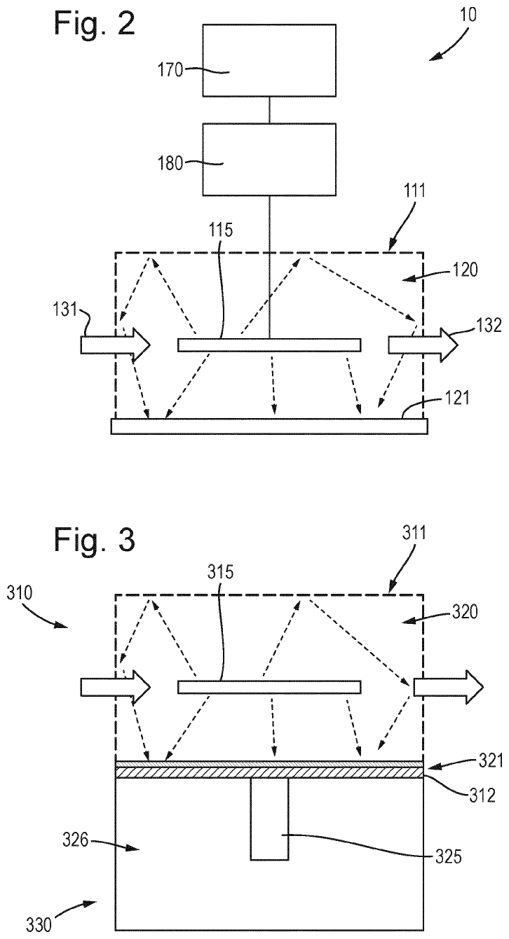

The electronic vapor provision device according to various embodiments may include a heating assembly 10 as schematically shown in FIG. 2. The heating assembly 10 may be connected to the control circuitry 30. According to various embodiments the heating assembly 10 uses radiofrequency (RF) electromagnetic radiation, such as microwave radiation, although other wavelengths may be used, to heat liquid vapor precursor material. RF electromagnetic radiation refers to electromagnetic radiation having a frequency within the range 30 Hz to 300 GHz. The RF electromagnetic radiation may have a frequency of 3 kHz to 300 GHz, optionally 3 MHz to 100 GHz, optionally 30 MHz to 30 GHz. The heating assembly 10 may comprise a signal generator 170, such as a voltage controlled oscillator (“VCO”), to generate a signal which is provided to a connected amplifier 180. The amplifier 180 may be connected to one or more antennas 115, which are arranged within a heating cavity 120. In some embodiments, the one or more antennas 115 comprises one or more patch antenna. In another embodiment, the one or more antenna 115 comprises one or more directional antenna. The control circuitry 30 can control the RF electromagnetic radiation which is generated by the one or more antennas 115, and in embodiments the frequency spectra which is generated by the one or more antennas 115. The one or more antennas 115 may also be referred to as an antenna arrangement 115.

The heating cavity 120 is defined by RF shield 111 which substantially prevents the RF electromagnetic radiation generated by the one or more antennas 115 from escaping from the heating cavity 120. The RF shield 311 defines the heating cavity 320, by delimiting the volume within which RF electromagnetic radiation is substantially prevented from escaping, as will be discussed below. The one or more antennas 115 are arranged within the heating cavity 120. RF electromagnetic radiation may be prevented from escaping the heating cavity 120 by a combination of reflection and absorption of the RF electromagnetic radiation and optionally the RF shield 111 may be configured to reflect more of the RF electromagnetic radiation back into the heating cavity 120 than is absorbed by the RF shield 111.

For instance, the RF shield 111 may be configured to have a directional reflectance of 0.5 to 1.0, optionally 0.7 to 1.0, for the RF electromagnetic radiation generated by the antennas 115, the directional reflectance being the radiant flux reflected by a surface, divided by that received by that surface. The RF shield 111 may be configured to have a directional absorptance of 0.0 to 0.7, optionally 0.1 to 0.5, for the RF electromagnetic radiation generated by the antennas 115, the directional absorptance being the radiant flux absorbed by a surface, divided by that received by that surface. Further, the RF shield 111 may be configured to have a directional transmittance 0.0 to 0.3, optionally 0.1 to 0.2, for the RF electromagnetic radiation generated by the antennas 115, the directional transmittance being the radiant flux transmitted by a surface, divided by that received by that surface. Additionally, the RF shield may be configured to have an effective attenuation coefficient of at least 0.05 mm⁻¹ optionally at least 0.1 mm⁻¹, optionally at least 0.2 mm⁻¹, optionally at least 0.5 mm⁻¹, for the RF electromagnetic radiation generated by the antennas, where the effective attenuation coefficient is the radiant flux absorbed and scattered by a volume per unit length, divided by that received by that volume.

In some embodiments the RF shield 111 comprises a conductive material, a magnetic material, advantageously a conductive and magnetic material, and may comprise metal, for example aluminum, copper, brass, nickel, or other metals. Aluminum, copper, brass, and nickel are particularly useful as they have a desirably high degree of reflectance and shininess, in addition to conductivity. The RF shield 111 may comprise a substrate (e.g. an electrically insulating substrate) with a metallic coating, such as metallic ink. In embodiments the RF shield 111 may comprise an alloy comprising aluminum or copper. In some embodiments the RF shield 111 comprises a reflective foil. The RF shield 111 may comprise a sheet metallic material. In other embodiments, the RF shield 111 may comprise a metallic gauze or mesh. For instance, the RF shield 111 may comprise openings having a width of 5 mm or less, optionally 2.5 mm or less, optionally 1.5 mm or less, optionally 1.0 mm or less, optionally 0.5 mm or less, optionally 0.2 mm or less, optionally 0.1 mm or less. While any of these dimensions of openings may be applied to the liquid transport region or air permeable regions, as discussed below, openings having a width of 2.5 mm or less may be well suited to allowing both air and liquid, and a mixture of air, liquid, and/or vapor, to pass through, while openings having a width of 0.5 mm or less may be suitable for allowing liquid to pass through. These narrow openings are sufficient to substantially prevent the escape of the RF electromagnetic radiation from the heating cavity 120, while still permitting fluid to pass there through. In embodiments, the openings may have a width which is smaller than the smallest wavelength of the RF electromagnetic radiation generated by the antennas 115. Further, in regions of the RF shield 111 which comprise openings, (e.g. the liquid transport region or air permeable regions, as discussed below) the openings may cover 20% to 80%, optionally 40% to 60%, of the surface area in these regions. This proportion of openings may enable desirable volumes of fluid to pass through the RF shield 111, while remaining structurally stable.

As such, when the one or more antennas 115 are used to generate RF electromagnetic radiation, material within the cavity may become heated by exposure to this radiation, through the mechanism of dielectric heating in which polar molecules of the material within the cavity are driven to rotate by the RF electromagnetic radiation, thereby causing the material within the cavity to be vaporized. However, the RF shield 111 may be arranged to substantially prevent the RF electromagnetic radiation from escaping the cavity 120. This is important, particularly for an electronic vapor provision device which is handheld, as any RF electromagnetic radiation which did escape from the heating cavity 120 would escape in close proximity to the user. In one regard, providing the RF shield can help prevent the escape of RF radiation outside of the RF shield and thus provide a relatively safe heating mechanism (in respect of preventing the user from being exposed to RF radiation). Additionally, in instances where the RF shield is at least partially reflective to the RF radiation, the intensity of RF electromagnetic radiation generated may be increased within the bounds of the RF shield.

As will be discussed in more detail below with regard to exemplary embodiments, liquid vapor precursor material may be provided to the heating cavity 120 by liquid transport region 121 of the RF shield 111. In order to enable liquid vapor precursor material to enter the heating cavity 120, while still containing the RF electromagnetic radiation, the liquid transport region 121 corresponds to a portion of the RF shield 111 which is configured to permit the passage of fluid thereacross, but which is still configured such that RF electromagnetic radiation is substantially prevented from traversing, i.e. escaping the heating cavity 120. Accordingly, the liquid transport region 121 allows liquid to enter the heating assembly without requiring a gap in the RF shield which would substantially permit RF electromagnetic radiation to escape.

To achieve this, the liquid transport region 121 of the RF shield 111 comprises openings which are dimensioned to permit the flow of liquid there through, but which are of a dimension which substantially prevents RF electromagnetic radiation from passing there through, which may have the dimensions discussed above. As will be discussed in more detail below, the liquid transport region 121 may be defined by one or more wicking members, which are configured to transfer liquid from a liquid source across the RF shield 111 by capillary action. It should be understood that the extent or magnitude of the capillary action may be affected both by the properties of the liquid that is being wicked (e.g., the viscosity) as well as the size of the openings (or more generally capillary channels) of the liquid transport region 121. However, although many of the following examples will be discussed in the context of liquid transport regions being provided by one or more wicking members, these may each be applied more generally to arrangements in which the one or more liquid transport regions are provided that may or may not have wicking properties. In other words, the one or more wicking members may be generalised to one or more liquid transport regions which permit the transmission of fluid there across, but prevent the transmission of RF electromagnetic radiation thereacross.

As shown in detail in the various embodiments discussed below, the liquid transport region 121 of the RF shield 111 is in fluid communication with the one or more liquid sources 20. Liquid vapor precursor material is able to flow from the one or more liquid reservoirs, and through the liquid transport region 121 into the heating cavity 120. The liquid transport region 121 may comprise one or more liquid transport regions 121 arranged in distinct regions with respect to the heating cavity 120, each in fluid communication with a corresponding liquid source of the one or more liquid source. In embodiments, the liquid vapor precursor material may be drawn by capillary action through the liquid transport region 121. Each liquid source 20 may comprise a flow control element which is configured to control the flow of liquid from the liquid reservoir of liquid source, and the one or more liquid sources 20 may be connected to the control circuitry 30, such that flow from each liquid reservoir into the heating cavity 120 may be controlled by the control circuitry 30. Alternatively, the liquid transport region 121 may be arranged to provide certain liquid feed rates (e.g., by suitable number of openings/size of openings relative to the properties of the respective liquid source) to control the relative amounts of the liquids within the RF shield 111.

Once inside the cavity, the liquid vapor precursor material may be retained by a support structure (not shown) which is configured to retain liquid vapor precursor material within the cavity. In the case that multiple liquid transport regions are present, each may be configured to deliver liquid vapor precursor material to a respective support structure. This support structure may be (a region of) the inner wall of the RF shield 111 (e.g. at the liquid transport region), and/or may be a separate support structure arranged within the heating cavity 120, i.e. an internal support structure. As well as substantially preventing the RF electromagnetic radiation from escaping the heating cavity 120, the RF shield 111 may also be configured so as to best direct the radiation towards the support structure, and the liquid vapor precursor material retained thereby. When the one or more antennas 115 are used to generate RF electromagnetic radiation within the heating cavity 120, it is this liquid vapor precursor material which is within the cavity and retained by the support structure which is heated, and at least partially vaporized to generate vapor in the heating cavity 120. This may be a relatively small amount of liquid vapor precursor material, so advantageously it may be heated and vaporized quite quickly. As such it is also important to ensure that the control circuitry 30 is configured to control the heating assembly 10 in a manner which ensures that this vaporization occurs under optimal conditions, as will be discussed in more detail. To this end, the heating assembly 10 may comprise one or more sensors, including a temperature sensor, a chemical sensor, and/or a moisture sensor, for detecting the conditions in the cavity, the one or more sensors being connected to the control circuitry 30. Alternatively, the temperature could be estimated using an algorithm, such as an algorithm applying observer control theory, or artificial intelligence and/or machine learning.

The electronic vapor provision device 1 may comprise an air flow path extending between the heating cavity 120, which acts as a vapor generation chamber, and an air outlet such as an opening in the mouthpiece, so that a user inhaling on the outlet via the mouthpiece may draw air from the heating cavity 120, including any vapor in the heating cavity 120 which has been generated from the liquid vapor precursor material, for inhalation by the user. The flow path may begin at an air inlet, such as an inlet in the outer housing (not shown), for directing air towards the heating cavity 120, and is defined by one or more air channels (not shown). In order to facilitate this airflow through the heating cavity 120, the RF shield 111 can also comprise air permeable regions, which may comprise openings in the RF shield 111, which nonetheless still substantially prevent the escape of RF electromagnetic radiation from the cavity. These air permeable regions of the RF shield 111 may comprise openings of width 2.5 mm or less, and may be metallic as discussed above. This allows airflow 131 into the heating cavity 120, which can collect vapor which has been generated by the dielectric heating within the cavity, and leave the heating cavity as airflow 132 to be inhaled by a user. As shown in FIG. 2, and the subsequent Figs., the airflow entering and/or leaving the heating cavity is indicated by one or more arrows which pass through the RF shield, which indicate an exemplary passage of airflow (optionally including vapor generated in the cavity during use) through the RF shield. In order to facilitate this, a first air permeable region may be arranged at one side of the heating cavity 120, and a second air permeable region is arranged at the other, opposing, side of the heating cavity 120, such that air is drawn into the heating cavity (e.g. from the air inlet), through the first air permeable region, through the heating cavity, and out of the second air permeable region.

FIG. 3 shows a cross-sectional view through a schematic representation of a heating assembly 310 and liquid source 330 of an electronic vapor provision device, according to various embodiments of the disclosure. As discussed above, the electronic vapor provision device 1 may comprise multiple liquid sources 330 each comprising a liquid reservoirs, each liquid reservoir comprising liquid vapor precursor material. While FIG. 3 depicts a single liquid reservoir, the concepts discussed herein are equally applicable to arrangements in which liquid vapor precursor material is supplied to the heating cavity 120 from multiple liquid sources 330.

The heating assembly 310 corresponds to a particular embodiment of the format of heating assembly discussed above with regard to FIG. 2. In the same manner, it comprises RF shield 311, which defines a heating cavity 320 that contains one or more antennas 315, which may be controlled to generate RF electromagnetic radiation. As shown in FIG. 3, the heating assembly 310 may be arranged adjacent to a liquid source 330 and may be in fluid communication with the liquid source 330.

According to various embodiments, one or more portions of the RF shield 311 may form one or more wicking members 312. The one or more wicking members 312 may comprise a liquid transport region 321. In addition to being configured to permit the passage of liquid thereacross, but still being configured such that RF electromagnetic radiation is substantially prevented from traversing, the one or more wicking members 312 which define liquid transport region 321 also act to wick liquid vapor precursor material from liquid source 330 into the heating cavity 320.

The one or more wicking members 312 may comprise a metallic material. Providing a metallic material for the one or more wicking material 312 can ensure the wicking material provides RF shielding. In certain embodiments, the one or more wicking members 312 comprise steel, such as stainless steel. The metallic material may be coated, for example with a conductive layer such as graphene or carbon. For instance, this can be readily provided by using a mesh. Advantageously the one or more wicking members 312 may comprise a sintered mesh, which comprises a plurality of metal (e.g. steel, stainless steel) strands which have been overlaid and processed such that the strands become fused or bonded where the strands contact or overlap one another. This arrangement allows a three dimensional structure to be created, in which the dimensions of open space can be finely controlled, which can exhibit an effective capillary attraction for liquids and can enable a high liquid throughput.

The one or more wicking members 312 may comprise a plurality of beads, which enables the interstitial space to be selected from the dimensions of the beads used. These beads may be formed from a metallic material, or may be formed from a non-metallic material such as glass, and may be coated with e.g. a metallic material. Further, the one or more wicking members 312 may comprise a foam structure, comprising any of the materials discussed above.

Further, it is noted that the one or more antenna 315 may be formed from any of the described constructions discussed with regard to the one or more wicking members 312. For instance, the one or more antenna 315 may be formed from a material discussed above, the one or more antenna 315 may be a coated material as discussed above, and/or the one or more antenna 315 may comprise a sintered mesh.

The one or more portions of the RF shield 311 forming one or more wicking members 312 may be arranged to transfer a liquid from a liquid reservoir 326 by capillary action. For capillary action to occur, the one or more wicking member must comprise narrow holes such that liquid is drawn through the wicking member to an inside surface of the one or more wicking members, i.e. the surface of the one or more wicking members 312 which on the inside of the heating cavity 320. Accordingly, in certain embodiments the one or more wicking members 312 comprise a plurality of filaments or fibers, a mesh, or a foam. In embodiments, the one or more wicking members 312 may comprise one or more extended openings, such as a tubular or planar channel which is configured to provide capillary action, and which may have a narrow opening of less than 1 mm or less than 200 μm.

The one or more wicking members 312 are in fluid communication with the liquid vapor precursor material of the liquid source 330. The one or more wicking members 312 can draw liquid vapor precursor material from the liquid reservoir to the inner surface of the one or more wicking members 312, which faces the one or more antenna 315. As such, in this case the one or more wicking members 312 act as the support structure discussed above with regard to FIG. 2. Accordingly, RF electromagnetic radiation generated from the one or more antennas 315 are able to interact with and heat the liquid vapor precursor material within the heating cavity 320, thereby allowing a vapor to be generated.

In certain embodiments, the one or more wicking members 312 of the RF shield 311 may extend into the liquid source 330, for example into the one or more liquid reservoirs. In other embodiments, the one or more wicking members 312 of the RF shield 311 may be in fluid communication with one or more reservoir wicking members 325 which are disposed within the reservoir. Such reservoir wicking members 325 disposed within the reservoir may not need to provide RF shield, and as such may comprise a non metallic fibrous or porous material, for example, a ceramic material, an organic plant based material, pulp, polyamide fibers, or cotton.

Additionally, although the one or more wicking members 312 may form part of the RF shield 111, they may also comprise non-shielding wicking material in order to aid with the wicking of fluid across the RF shield 111 and into the heating cavity 120. For instance, the one or more wicking members 312 may comprise a non-metal material such as glass, fiberglass, ceramic, graphite, cotton or a polymer material, such as a synthetic polymer (e.g. rayon), or a non-synthetic (natural) polymer such as cellulose. These may also have many of the structural properties discussed above with regard to the one or more wicking members 312 and they may also be porous or sintered.

As discussed above, because RF electromagnetic radiation cannot penetrate the RF shield 311, only the liquid vapor precursor material on the inner surface of the one or more wicking members 312 facing the antenna may be vaporized. Accordingly, only a small volume of liquid vapor precursor material may be vaporized at any one time. This may be advantageous in allowing for vapor to be generated more quickly.

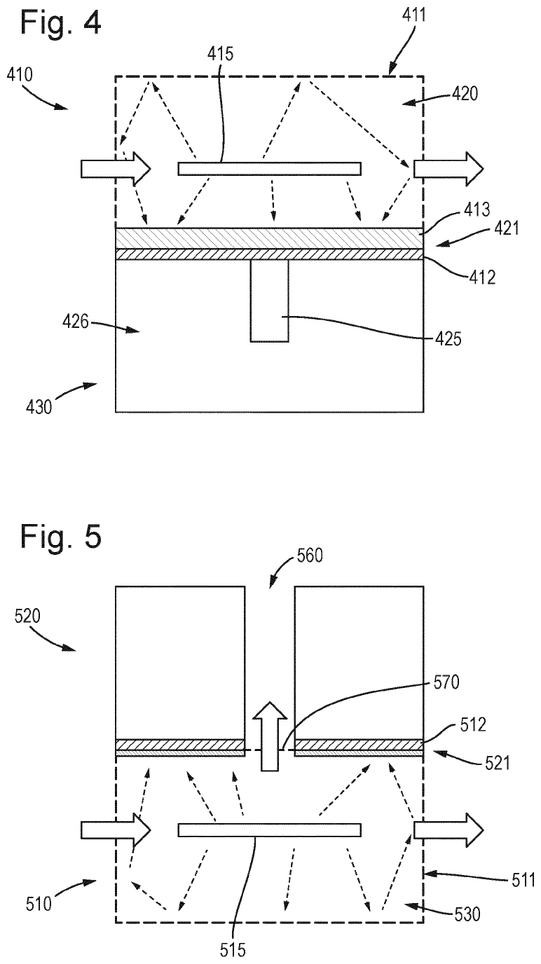

However, in certain implementations, it may be beneficial to vaporize a larger volume of liquid. FIG. 4 illustrates schematically a heating arrangement in accordance with various embodiments. This arrangement comprises a heating assembly 410 and liquid source 430, which is similar to the arrangement of FIG. 3. The heating assembly 410 comprises one or more antennas 415 arranged within a heating cavity 420 defined by RF shield 411. The liquid source 430 is arranged adjacent to and in fluid communication with the heating assembly, and comprises one or more wicking members 425 in the liquid reservoir 426 of the liquid source 430.

The RF shield 411 also comprises a liquid transport region 421 (e.g. provided by one or more wicking portions 412 in the RF shield 411), through which liquid vapor precursor material may travel from the liquid source 430. However, in contrast to the arrangement of FIG. 3, the heating assembly 410 of FIG. 4 also comprises an internal support structure 413 which is arranged within the heating cavity 420. This internal support structure 413 is in fluid communication and contact with the one or more wicking portions 412 of the RF shield 411 (and in other words is in fluid communication with the liquid transport region 421) and is configured to receive liquid vapor precursor material from the liquid transport region 421.

The internal support structure 413 thus acts as a volume within the heating cavity 420 for retaining liquid vapor precursor material. As such, it can allow the amount of liquid vapor precursor material within the heating cavity 420 to be increased. Additionally, it can be shaped and arranged to improve exposure of the liquid vapor precursor material stored therein to the RF electromagnetic radiation from the one or more antennas 415.

The internal support structure 413 may comprise a material which does not provide RF shielding such as a non metallic fibrous or porous material, for example, a ceramic material, an organic plant based material, pulp, polyamide fibers, or cotton, or even a sintered material such as a sintered glass. Additionally, the internal support structure 413 can comprise a wicking material i.e. the support structure 413 may correspond to one or more internal wicking members 413. These may be arranged to transfer a liquid into the heating cavity 420 from the liquid transport region 421 by capillary action. For capillary action to occur, the one or more internal wicking members 413 may comprise narrow holes such that liquid is drawn through the one or more internal wicking members 413 to propagate into the heating cavity 420. Accordingly, in certain embodiments the one or more internal wicking members 413 may comprise a plurality of filaments or fibers, a mesh, or a foam. The internal wicking members 413 may also be non-shielding i.e. being configured such that they do not substantially prevent the transmission of RF electromagnetic radiation there through.

The internal support structure 413 may provide a liquid capacity of 0.1 to 10 μl within the heating cavity, optionally 0.1 to 5 μl, optionally 0.5 to 1 μl. Further, the internal support structure 413 may have a surface area of 20 to 100 mm², and a volume of 2 to 50 mm³, giving a surface area to volume ratio of at least 0.4 mm⁻¹, optionally 1 to 50 mm⁻¹. The material structure of the internal support structure 413 may also be such that the percentage of open space within the internal support structure 413 is 50 to 90%.

While this concept of using a support structure, such as one or more internal wicking members, within the heating cavity is discussed here in the context of the arrangement shown in FIG. 4, it is understood that this arrangement could be applied to any other embodiment disclose herein. Additionally, this may also be applied to arrangements in which the electronic vapor generation device 1 comprises or receives a plurality of liquid source 430, comprising a plurality of respective liquid reservoirs 426; in which case the one or more internal wicking members may be arranged such that a wicking member is arranged in fluid communication with a liquid transport region of the plurality of liquid transport regions corresponding to the plurality of respective liquid reservoirs.

FIG. 5 shows schematically an exemplary embodiment of an electronic vapor provision device 1 according to an embodiment comprising a heating assembly 510 and liquid source 520. As with the arrangement shown in FIG. 2, the heating assembly 510 comprises one or more antennas 515 arranged within a heating cavity 520 defined by RF shield 511. The liquid source 520 is arranged adjacent to and in fluid communication with the heating assembly, and comprises a liquid reservoir of the liquid source 520.

The RF shield 511 also comprises a liquid transport region 521 (e.g. provided by one or more wicking portions 512 in the RF shield 511), through which liquid vapor precursor material may travel from the liquid source 530, into the heating cavity 520. In the embodiment depicted, the liquid source is arranged such that the one or more liquid reservoirs define a central channel 560 there through. For example, the one or more liquid reservoirs may be arranged in an annular arrangement, which defines the central channel 560. The central channel 560 may be arranged to provide a portion of the flow path, from an air permeable region 570 of the RF shield 511, towards the outlet or mouthpiece.

As discussed above, the electronic vapor provision device 1 may be elongate, having an upper end and a lower end as defined by the orientation in which the user is intended to grip the device. In the embodiment shown in FIG. 5, the one or more liquid reservoirs are arranged above the heating assembly 510. As a result, the liquid transport region 521 is arranged towards the bottom of the liquid reservoirs, and as such the flow of liquid vapor precursor material is assisted by gravity, and the liquid transport region 521 will remain in fluid contact with the liquid vapor precursor material in the liquid reservoirs regardless of fill level.

In such an elongate structure, it is also important to reduce the form factor of the device. As such, by arranging the RF shield 511 such that an air permeable region 570 is directed upwards from the RF shield 511, i.e. towards the upper end of the electronic vapor provision device 1, at which the mouthpiece is generally positioned, there is no need to provide additional airflow components or guides around the peripheral of the heating cavity. As such, the minimum lateral dimension of the electronic vapor provision device 1 can be reduced.

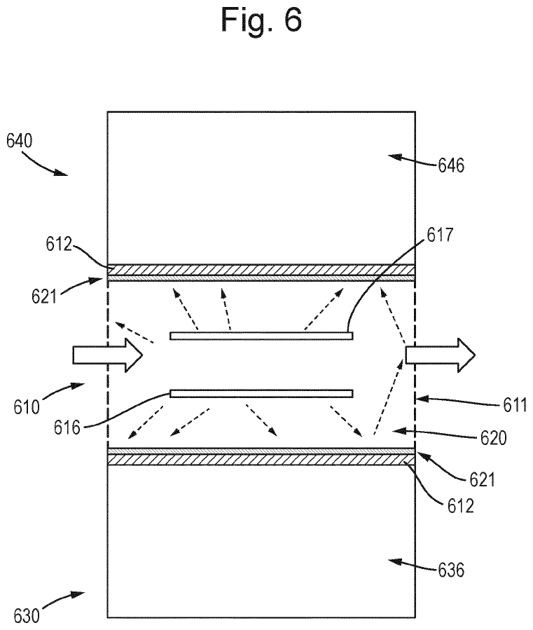

FIG. 6 shows schematically an embodiment of the electronic vapor provision device 1, comprising a heating assembly 610, first liquid source 630, and second liquid source 640. As with the arrangement shown in FIG. 2, the heating assembly 610 comprises a heating cavity 620 defined by RF shield 611. However, in this embodiment, the heating assembly comprises a first antenna 617 and a second antenna 616 arranged within the heating cavity 620. As discussed above, and as applies to all embodiments, these first antenna 617 and second antenna 616 are connected to control circuitry 30. The first antenna 617 and second antenna 616 may be controlled together in embodiment, i.e. such that they generate the same RF electromagnetic radiation. In other embodiments, these first antenna 617 and second antenna 616 are each configured to generate independent RF electromagnetic radiation.

The first liquid source 640 and second liquid source 630 are arranged adjacent to and in fluid communication with the heating assembly 610. In the embodiment depicted, the first liquid source 640 comprises a first liquid reservoir 646, and the second liquid source 630 comprises second liquid reservoir 636. Each of the first liquid reservoir 626 and second liquid reservoir 636 is in fluid communication with the heating cavity 620 via a respective liquid transport region 621 (e.g. provided by one or more wicking portions 612 in the RF shield 611) of the RF shield 611, which, in embodiments, is provided by one or more wicking members 621 of the RF shield 611 which define the liquid transport regions 621. In addition to a liquid reservoir, each liquid source comprises a flow control element, which is configured to control the flow of liquid from the liquid reservoir of the liquid source to the respective liquid transport region; these flow control elements being connected to the control circuitry such that the control circuitry can control the delivery of liquid vapor precursor material from each liquid source into the heating cavity. Each flow control element can also optionally comprise a pump.

While this is discussed in the context of two liquid sources, of course, these concepts may be applied where three or more liquid sources are used. Additionally, the same applies for a modular or multi-part electronic vapor provision device, in which a replaceable cartridge is used as discussed above. For instance, instead of each liquid source being arranged within the outer housing and comprising a liquid reservoir and optionally a flow control element, each liquid source may correspond to a replaceable cartridge comprising a liquid reservoir and flow control element, which is configured to engage with the outer housing (providing a “reusable device part” as discussed above) such that fluid communication is enabled with the heating cavity. Alternatively or additionally to the flow control element in the cartridge, a flow control element which is configured to control the flow of fluid from the liquid source of the cartridge may be arranged within the outer housing.

By having first liquid reservoir 646 and second liquid reservoir 636, the first liquid source 640 and second liquid source 630 are able to provide different liquid vapor precursor material to the heating cavity, such as different flavors or compositions. For example, the first liquid source 640 may contain and be configured to deliver a first composition e.g. containing glycerol, while the second liquid source 630 may contain and be configured to deliver a second composition e.g. containing propylene glycol. By controlling the independent delivery of these different material independently, it is possible to control the active substance strength and flavor, as well as the visibility of exhalate.

Additionally, the first antenna 617 may be arranged such that RF electromagnetic radiation generated therefrom is directed at vaporizing liquid vapor precursor material from the first liquid reservoir 646 (e.g. directed at the support structure which the liquid vapor precursor material from the first liquid reservoir 626 is retained by, whether this is the RF shield inner wall or an internal support structure within the heating cavity 620), while the second antenna 616 is arranged such that RF electromagnetic radiation generated therefrom is directed at vaporizing liquid vapor precursor material from the second liquid reservoir 636 (e.g. directed at the support structure which the liquid vapor precursor material from the second liquid reservoir 636 is retained by, whether this is the RF shield inner wall or an internal support structure within the heating cavity 620). This can allow the control circuitry 30 to independently control generation of RF electromagnetic radiation from the first and second antennas respectively, so as to independently control vaporization of fluid from the first and second liquid reservoirs respectively.

It is noted that the provision of first and second antennas could be applied to any embodiment of the present disclosure, for example in the case that each antenna is optimised to generate an independent frequency of RF electromagnetic radiation. Additionally, the provision of a first liquid reservoir 626 and second liquid reservoir 636 as shown in FIG. 6 could be provided, as discussed above, regardless of whether one or more antennas are provided in the heating assembly 610.

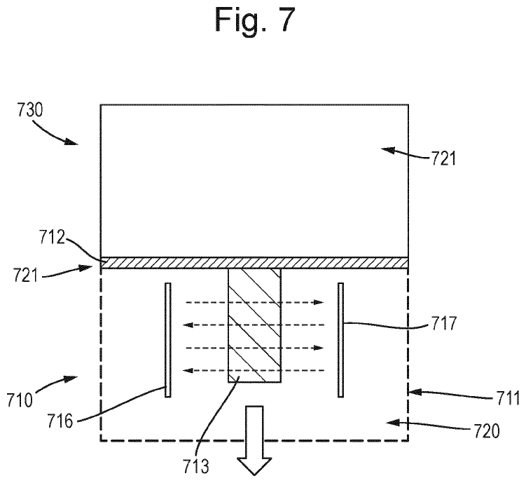

FIG. 7 shows schematically an embodiment of the electronic vapor provision device 1, comprising a heating assembly 710 and liquid source 730. As with the arrangement shown in FIG. 4, the heating assembly 710 a heating cavity 720 defined by RF shield 711. The liquid source 730 is arranged adjacent to and in fluid communication with the heating assembly, and comprises one or more liquid reservoirs of the liquid source 730. The RF shield 711 also comprises a liquid transport region 721 (in embodiments defined by one or more wicking members 712 in the RF shield 711), through which liquid vapor precursor material may travel from the liquid source 730, into the heating cavity 720.

In this particular embodiment, the heating assembly 710 comprises a first antenna section 717 and a second antenna section 716 arranged within the heating cavity 720. As discussed with regard to FIG. 6, these may be controlled by the control circuitry 30 so as to generate the same RF electromagnetic radiation, or to independently generate RF electromagnetic radiation. For example, the first antenna section 717 and second antenna section 716 may correspond to different portions of an antenna arrangement, such as a hollow antenna arrangement, e.g. a helical antenna. A high frequency voltage may be applied to the first antenna section 717 and second antenna section 716 in phase, or in anti-phase so as to act as a capacitor where the flux is concentrated between the two sections.

In particular, the first antenna section 717 and second antenna section 716 may correspond to a first terminal and second terminal of a capacitor respectively, and the RF electromagnetic radiation being generated by applying an alternating voltage to these first and second terminals. Optionally, the first antenna section 717 and second antenna section 716 may comprise a first plate and a second plate respectively; particularly in the case that the first antenna section 717 and second antenna section 716 correspond to terminals of a capacitor.

An internal support structure 713 is also provided, which extends into the heating cavity 720, optionally at least 50 mm. The internal support structure 713 may be constructed in the accordance with the embodiments of the internal support structure of FIG. 4. Alternatively, it may be formed from a material which provides RF shield, and it may be a protrusion of the one or more wicking members 712 of the RF shield 711. The internal support structure 713 may be a longitudinal structure, for example in the form of a sheet or layer thus having an improved surface area to volume ratio.

The first antenna section 717 and second antenna section 716 are arranged such that RF electromagnetic radiation transmitted (e.g. directly) between the two antenna sections is incident upon the internal support structure 713. The antenna arrangement may define a volume within which the internal support structure 713 is arrangement, and may even surround the internal support structure 713. This can ensure that the RF electromagnetic radiation generated by the antenna arrangement is particularly well directed towards the internal support structure 713, and the liquid vapor precursor material retained thereon. Preferably, the internal support structure 713 extends sufficiently far into the heating cavity 730 that the radiation transmitted between the first antenna section 717 and the second antenna section 716 arrives directly at the surface of the internal support structure 713, i.e. without being reflected off an intermediate object.

In embodiments, the internal support structure 713 is arranged at the midpoint between the first antenna section 717 and the second antenna section 716. This may mean that the field of the RF electromagnetic radiation is concentrated at the location of the internal support structure 713, meaning that there is an effective provision of energy to the internal support structure 713. This arrangement may be particularly effective in the case of the voltage being applied to the first antenna section 717 and the second antenna section 716 being in antiphase, due to the resulting arrangement of the field.

In a particular arrangement, the first antenna section 717 is a first antenna, and the second antenna section 716 is a second antenna. In other words, the internal support structure extends into the heating cavity 720 between the first antenna 717 and the second antenna 716. This may allow more exposure of the liquid vapor precursor material retained by the internal support structure 713 to the RF electromagnetic radiation generated by the antennas and particularly transferred between the antennas.

Additionally, as shown in FIG. 7, the internal support structure 713 extends in a longitudinal direction between the first antenna section 717 and the second antenna section 716. The antenna structure is open at the longitudinal ends of the internal support structure 713, so airflow can be drawn along the longitudinal length of the support structure 713. An elongate support structure 713 has improved surface area, and this arrangement can allow airflow to be drawn along the length of the support structure 713 such that maximum vapor leaving the support structure 713 can be drawn with the airflow. While not depicted in FIG. 7, it may also be advantageous to arrange the air permeable regions to be arranged in the RF shield such that airflow is drawn through the heating cavity 720 along the longitudinal direction of the support structure 713.

Further, although FIG. 7 depicts an internal support structure 713 arranged in combination with an antenna arrangement comprising first antenna section 717 and second antenna section 716, a plurality of internal support structures may be provided, each having an associated antenna arrangement comprising first antenna section and second antenna section. In such an array type arrangement, each internal support structure may configured to receive liquid vapor precursor material from a corresponding liquid transport region. In other words, this concept may be applied to an arrangement comprising multiple liquid reservoirs, such as that depicted in FIG. 6.

It is noted that although FIG. 7 discloses an arrangement in which internal support structure 713 extends into the heating cavity between first and second antennas, this arrangement of an internal support structure may also be utilized with any antenna arrangement, regardless of whether multiple antenna sections are arranged on either side of the internal support structure or not.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. An electronic vapor provision device comprising:
an antenna arrangement for generating radio frequency (RF) electromagnetic radiation for heating a liquid to generate a vapor for inhalation by a user, wherein the antenna arrangement comprises a first section and a second section;
a controller for controlling the RF electromagnetic radiation generated by the antenna arrangement;
an RF shield for shielding the user from RF electromagnetic radiation, wherein the RF shield at least in part defines a heating cavity within which the RF electromagnetic radiation generated by the antenna arrangement is contained; and
an internal support structure arranged at least partially within the heating cavity, and arranged between the first section and the second section of the antenna arrangement.

2. An electronic vapor provision device as claimed in claim 1, wherein the internal support structure is non-shielding such that RF electromagnetic radiation is able to pass through the internal support structure.

3. An electronic vapor provision device as claimed in claim 1, wherein the internal support structure comprises one or more internal wicking members, optionally wherein the one or more internal wicking members are arranged to transfer a liquid from a liquid source by capillary action.

4. An electronic vapor provision device as claimed in claim 1, wherein the internal support structure comprises glass, fiberglass, ceramic, graphite, cotton or a polymer material.

5. An electronic vapor provision device as claimed in claim 1, wherein the internal support structure comprises a plurality of filaments or fibers, a mesh, or a foam.

6. An electronic vapor provision device as claimed in claim 5, wherein the internal support structure comprises graphene foam or polyimide foam.

7. An electronic vapor vapour provision device as claimed in claim 1, wherein the internal support structure is porous.

8. An electronic vapor provision device as claimed in claim 1, wherein the internal support structure is sintered.

9. An electronic vapor provision device as claimed in claim 1, wherein the antenna arrangement defines an internal volume within the antenna arrangement, and wherein the internal support structure extends within the internal volume.

10. An electronic vapor provision device as claimed in claim 9, wherein the internal support structure extends longitudinally within the internal volume.

11. An electronic vapor provision device as claimed in claim 10, wherein the internal volume extends longitudinally in the same direction as the internal support structure, and wherein the longitudinal ends of the antenna arrangement are open.

12. An electronic vapor provision device as claimed in claim 1, wherein the first section and second section correspond to portions of the same antenna.

13. An electronic vapor provision device as claimed in claim 1, wherein the first antenna section comprises a first antenna, and wherein the second antenna section comprises a second antenna.

14. An electronic vapor provision device as claimed in claim 1, wherein the internal support structure has a liquid capacity of 0.1 to 10 μl.

15. An electronic vapor provision device as claimed in claim 1, wherein at least a portion of the internal support structure extends through a portion of the RF shield.

16. An electronic vapor provision device as claimed in preceding claim 1, wherein the RF shield comprises one or more air permeable regions which are configured to allow air and vapor to pass there through, and an air outlet.

17. An electronic vapor provision device as claimed in claim 16, wherein the air outlet comprises a mouthpiece.

18. An electronic vapor provision device as claimed in claim 16, further comprising an air inlet.

19. An electronic vapor provision device as claimed in claim 18, further comprising an air flow path extending from the air inlet, into the heating cavity through the one or more air permeable regions, through the heating cavity, out of the heating cavity through the one or more air permeable regions, and to the air outlet.

20. An electronic vapor provision device as claimed in claim 16, wherein the one or more air permeable regions comprise a first air permeable region for air flow to enter the heating cavity and a second air permeable region for air flow to leave the heating cavity.

21. An electronic vapor provision device as claimed in claim 20, wherein the first and second air permeable regions are arranged at opposing ends of the heating cavity, optionally so as to direct airflow between the first section and second section, and along the internal support structure.

22. An electronic vapor provision device as claimed in claim 1, further comprising a signal generator for generating a radio frequency signal to provide to the at least one antenna.

23. An electronic vapor provision device as claimed in claim 22, wherein the signal generator is configured to generate radiofrequency signals at one or more frequencies within the range of 30 Hz to 300 GHz.

24. An electronic vapor provision system comprising:
an electronic vapor provision device as claimed in claim 1; and
a supply of liquid which in use is vaporized vapourised to form a vapor for inhalation by a user.

25. A method of generating vapor comprising:
generating radio frequency (RF) electromagnetic radiation for heating a liquid to generate a vapor for inhalation by a user using an antenna arrangement comprising a first section and a second section;
controlling the RF electromagnetic radiation generated by the antenna arrangement;
providing an RF shield for shielding the user from RF electromagnetic radiation, wherein the RF shield at least in part defines a heating cavity within which the RF electromagnetic radiation generated by the at least one antenna is contained; and
providing an internal support structure arranged at least partially within the heating cavity, and arranged between the first section and the second section of the antenna arrangement.
